(19) United States
(12) Patent Application Publication
(10) Pub. No.: US 2024/0280883 A1
(43) Pub. Date: Aug. 22, 2024

(54) PRISM BLOCK, CAMERA MODULE, AND METHOD FOR MANUFACTURING PRISM BLOCK

(71) Applicant: Sharp Sensing Technology Corporation, Tenri City (JP)

(72) Inventors: Sae MANO, Tenri City (JP); Yoshihito ISHIZUE, Tenri City (JP)

(21) Appl. No.: 18/581,583

(22) Filed: Feb. 20, 2024

(30) Foreign Application Priority Data
Feb. 22, 2023 (JP) 2023-026310

(51) Int. Cl. G03B 17/17

(52) U.S. Cl. CPC G03B 17/17

(57) ABSTRACT

A prism block includes the following: a holder having an opening surface and a mounting surface perpendicular to the opening surface; and a prism configured to receive first light that travels in a first direction, and to cause second light that travels in a second direction perpendicular to the first direction to exit. The prism is positioned and retained by the holder while being in abutment with the mounting surface.

### BACKGROUND OF THE INVENTION

### Field of the Invention

The present disclosure relates to a prism block, a camera module, and a method for manufacturing a prism block. The present application claims priority from Japanese Application JP2023-26310, filed on Feb. 22, 2023, the content of which is hereby incorporated by reference into this application.

### Description of the Related Art

Japanese Unexamined Utility Model Application Publication No. Hei 6-50012 discloses a beam splitter. The beam splitter has a mounting surface formed on its prism fixing stage. The mounting surface is formed at a tilt angle θ1. Further, the bottom surface of its first prism and the bottom surface of its second prism are in surface-contact together, thus forming a light-ray-bundle reflecting surface. The bottom surface of the first prism is provided with a joint surface. The joint surface is formed on both sides of the light-ray-bundle reflecting surface. The joint surfaces formed on the bottom surface of the first prism are in contact with the mounting surface formed on the prism fixing stage. Accordingly, the axis of incident light of the beam splitter with respect to the axis of reflected light of the same can be positioned at the right angle (paragraphs 0009, 0011, 0012, 0014, and 0018).

### SUMMARY OF THE INVENTION

In the beam splitter disclosed in Japanese Unexamined Utility Model Application Publication No. Hei 6-50012, the positional accuracy of the first prism and second prism depends on the accuracy of forming the mounting surface, which is formed on the prism fixing stage at the tilt angle θ1.

However, this formation accuracy of the mounting surface formed at the tilt angle θ1 is often lower than the formation accuracy of a level surface. Hence, the positional accuracy of the first prism and second prism is often low in the beam splitter.

One aspect of the present disclosure has been made in view of this problem. One aspect of the present disclosure aims to provide a prism block, a camera module, and a method for manufacturing a prism block all of which can, for instance, enhance the positional accuracy of a prism.

A prism block according to a first aspect of the present disclosure includes the following: a holder having an opening surface and a mounting surface perpendicular to the opening surface; and a prism configured to receive first light that travels in a first direction, and to cause second light that travels in a second direction perpendicular to the first direction to exit. The prism is positioned and retained by the holder while being in abutment with the mounting surface.

A camera module according to a second aspect of the present disclosure includes the following: the prism block according to the first aspect of the present disclosure; an optical system configured to cause the second light to form an image; and an image pickup element configured to take the image.

A method for manufacturing a prism block according to a third aspect of the present disclosure includes the following: inserting a prism into a holder having an opening surface and a mounting surface perpendicular to the opening surface via the opening surface, and bringing the prism into abutment with the mounting surface, the prism being configured to receive first light that travels in a first direction, and to cause second light that travels in a second direction perpendicular to the first direction to exit; and causing the holder to position and retain the prism while bringing the prism into abutment with the mounting surface.

### BRIEF DESCRIPTION OF THE DRAWINGS

FIG. 1 is a schematic sectional view of a camera module according to a first preferred embodiment;

FIG. 2 is a schematic exploded perspective view of a prism block included in the camera module according to the first preferred embodiment;

FIG. 3 is a schematic sectional view of the prism block included in the camera module according to the first preferred embodiment and is a sectional view taken along line A-A in FIG. 2;

FIG. 4 schematically illustrates the prism block included in the camera module according to the first preferred embodiment, and an alignment mechanism for aligning this prism block;

FIG. 5 is a schematic plane view of an imaging surface included in the alignment mechanism, which is for aligning the prism block included in the camera module according to the first preferred embodiment;

FIG. 6 is a flowchart showing procedures for manufacturing the prism block included in the camera module according to the first preferred embodiment;

FIG. 7 is a schematic sectional view of the holder included in the camera module according to a second preferred embodiment; and

FIG. 8 is a schematic sectional view of the camera module according to a third preferred embodiment.

### DETAILED DESCRIPTION OF THE INVENTION

The preferred embodiments of the present disclosure will be described with reference to the drawing. It is noted that identical or equivalent components will be denoted by the same signs throughout the drawings, and that the description of redundancies will be omitted.

The drawings show, as necessary, the X-axis, Y-axis, and Z-axis of a three-dimensional orthogonal coordinate system respectively parallel to their X-direction, Y-direction, and Z-direction. Any two directions selected from among the X-direction, Y-direction, and Z-direction are perpendicular to each other.

### 1 First Preferred Embodiment

### 1.1 Camera Module

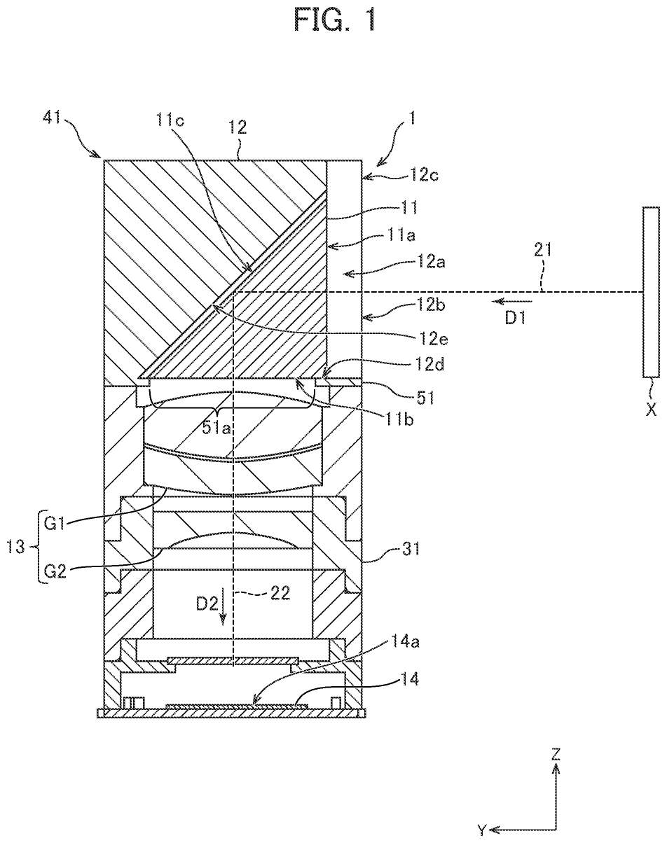

FIG. 1 is a schematic sectional view of a camera module according to a first preferred embodiment.

A camera module 1 according to the first preferred embodiment illustrated in FIG. 1 takes an image of an object X and outputs an image signal corresponding to the taken image. The camera module 1 is a folded-optical-system camera module that includes a folded optical system.

As illustrated in FIG. 1, the camera module 1 includes a prism 11, a holder 12, an optical system 13, and an image pickup unit 14.

The prism 11 receives first light that travels in a first direction D1 extending along a first optical axis 21. The prism 11 reflects the received first light to generate second light that travels in a second direction D2 extending along a second optical axis 22. The prism 11 causes the generated second light to exit.

The prism 11 bends an optical axis 90 degrees. Thus, the second optical axis 22 is perpendicular to the first optical axis 21. Thus, the second direction D2 is perpendicular to the first direction D1. The prism 11 constitutes a folded optical system.

The prism 11 is a 45° right-angle prism. The prism 11 thus has a first flat surface 11a, a second flat surface 11b, and an inclined surface 11c.

The second flat surface 11b of the prism 11 is perpendicular to the first flat surface 11a of the prism 11. The inclined surface 11c of the prism 11 is 45 degrees inclined with respect to the first flat surface 11a and second flat surface 11b of the prism 11. The prism 11 has a triangular-prism shape. The first flat surface 11a, the second flat surface 11b, and the inclined surface 11c are the side surfaces of the triangular-prism shape.

The first light enters the first flat surface 11a of the prism 11. The first light entered into the first flat surface 11a travels through the inside of the prism 11 and reaches the inclined surface 11c of the prism 11. The inclined surface 11c is previously processed into a total-reflection surface. The inclined surface 11c thus subjects the reached first light to total reflection to generate the second light. The generated second light travels through the inside of the prism 11 and reaches the second flat surface 11b of the prism 11. The second flat surface 11b causes the reached second light to exit.

The holder 12 retains the prism 11.

The optical system 13 is disposed at a stage posterior to the stage at which the prism 11 is disposed. The optical system 13 condenses the second light to cause the second light to form an image. The optical system 13 forms an image on an image formation surface 14a.

The image pickup unit 14 is disposed at a stage posterior to the stage at which the optical system 13 is disposed. The image pickup unit 14 takes the formed image to output an image signal. The image pickup unit 14 takes the formed image by subjecting the condensed light to photoelectric conversion into an electric signal. The image pickup unit 14 is, but not limited to, a complementary metal oxide semiconductor (CMOS) image sensor, or a charge-coupled device (CCD) image sensor.

### 1.2 Optical System

As illustrated in FIG. 1, the optical system 13 includes a first lens group G1, a second lens group G2, and an actuator block 31.

The first lens group G1 is disposed at a stage posterior to the stage at which the prism 11 is disposed. The first lens group G1 faces the second flat surface 11b of the prism 11.

The first lens group G1 receives the second light exited from the second flat surface 11b of the prism 11 and allows the received second light to pass therethrough. The first lens group G1 includes two or more lenses. The first lens group G1 has a positive power as a whole.

The second lens group G2 is disposed at a stage posterior to the stage at which the first lens group G1 is disposed. The second lens group G2 receives the second light passed through the first lens group G1 and allows the received second light to pass therethrough. The second lens group G2 includes at least one lens. The second lens group G2 has a negative power as a whole.

The actuator block 31 moves the second lens group G2 in a direction parallel to the second optical axis 22. This enables the optical system 13 to perform focusing. The actuator block 31 is provided with an actuator, which is not shown, and incorporates the actuator. The actuator moves the second lens group G2 in the direction parallel to the second optical axis 22.

The optical system 13 having the foregoing configuration may be replaced with an optical system having a configuration different from the foregoing configuration. For instance, the actuator block 31 may incorporate a whole group consisting of the first lens group G1 and second lens group G2 and may perform focusing by moving the whole group in the direction parallel to the second optical axis 22.

### 1.3 Prism Block

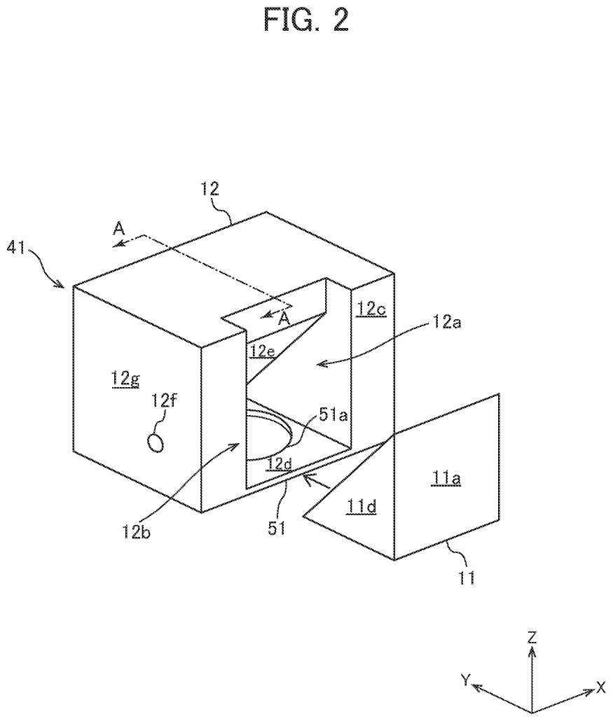

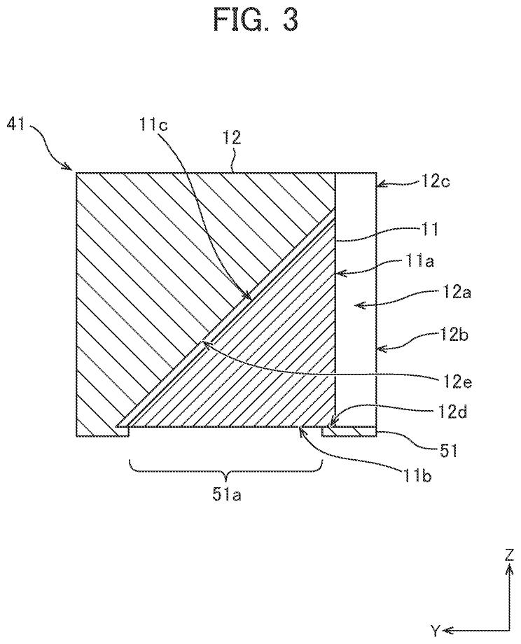

FIG. 2 is a schematic exploded perspective view of a prism block included in the camera module according to the first preferred embodiment. FIG. 3 is a schematic sectional view of the prism block included in the camera module according to the first preferred embodiment and is a sectional view taken along line A-A in FIG. 2.

A prism block 41 illustrated in FIG. 2 and FIG. 3 is incorporated in the camera module 1. The prism block 41 may be incorporated in an optical device other than the camera module 1.

As illustrated in FIG. 2 and FIG. 3, the prism block 41 includes the foregoing holder 12 and prism 11.

The holder 12 has an inner space 12a and an opening surface 12b.

The holder 12 houses the prism 11 in the inner space 12a. The holder 12 retains the prism 11 housed in the inner space 12a.

The inner space 12a of the holder 12 is exposed outside the holder 12 via the opening surface 12b of the holder 12. The inner space 12a has a larger tridimensional shape than the tridimensional shape of the prism 11. The opening surface 12b has a larger planar shape than the planar shape of the first flat surface 11a of the prism 11. The opening surface 12b can be thus used as an opening for inserting the prism 11. The prism 11 can be inserted into the inner space 12a via the opening surface 12b with the first flat surface 11a remaining parallel to the opening surface 12b.

The opening surface 12b of the holder 12 has a contour line including the edge of the holder 12 and is open in the minus Y-direction. The opening surface 12b is flush with an outer surface 12c of the holder 12. The inner space 12a of the holder 12 extends in the plus Y-direction, which is opposite to the minus Y-direction, from the opening surface 12b. Thus, the prism 11 is moved in the plus Y-direction to pass though the opening surface 12b when the prism 11 is inserted into the inner space 12a via the opening surface 12b.

The holder 12 has a mounting surface 12d. The mounting surface 12d is oriented in the plus Z-direction. The mounting surface 12d faces the inner space 12a of the holder 12. The mounting surface 12d is perpendicular to the opening surface 12b of the holder 12.

The second flat surface 11b of the prism 11 retained by the holder 12 is in surface-contact with the mounting surface 12d of the holder 12. The second flat surface 11b and the mounting surface 12d are thus abutment surfaces being in abutment with each other. Thus, the prism 11 is in abutment with the mounting surface 12d. The prism 11 is thus positioned in the Z-direction perpendicular to the mounting surface 12d. The prism 11 is thus positioned and retained by the holder 12.

The holder 12 has an inclined surface 12e. The inclined surface 12e is oriented in a direction 45 degrees inclined from the minus Y-direction to the minus Z-direction. The inclined surface 12e faces the inner space 12a of the holder 12. The inclined surface 12e of the holder 12 constitutes an opposing surface facing the inclined surface 11c of the prism 11.

In the prism block 41, the position of the prism 11 in the Y-direction is aligned by the amount of inserting the prism 11 in the plus Y-direction. Thus, the inclined surface 12e of the holder 12 is not in contact with the inclined surface 11c of the prism 11. That is, the inclined surface 12e of the holder 12 faces the inclined surface 11c of the prism 11 with a gap therebetween. The gap has a width of 100 μm or smaller for instance.

When the inclined surface 12e of the holder 12 and the inclined surface 11c of the prism 11, both inclined from level surfaces, are abutment surfaces for positioning, the positional accuracy of the prism 11 depends on the accuracy of forming the inclined surface 12e of the holder 12 and particularly depends on the accuracy of forming an angle between the inclined surface 12e of the holder 12 and the level surface. However, it is difficult to enhance this formation accuracy of the inclined surface 12e of the holder 12 inclined from the level surface. It is hence difficult to enhance the positional accuracy of the prism 11 when the inclined surface 12e of the holder 12 and the inclined surface 11c of the prism 11 constitute abutment surfaces for positioning.

In contrast to this, the positional accuracy of the prism 11 depends on the formation accuracy of the mounting surface 12d of the holder 12 when the mounting surface 12d of the holder 12 and the second plane 11b of the prism 11, both being level surfaces, constitute abutment surfaces for positioning. Moreover, enhancing the formation accuracy of the mounting surface 12d of the holder 12, being a level surface, is easy. It is hence easy to enhance the positional accuracy of the prism 11 in the Z-direction when the inclined surface 12e of the holder 12 and the inclined surface 11c of the prism 11 constitute abutment surfaces for positioning.

However, when the mounting surface 12d of the holder 12 and the second flat surface 11b of the prism 11 constitute abutment surfaces for positioning, there are variations in the sizes of the holder 12 and prism 11, and hence, positioning the prism 11 in the Y-direction is difficult. This produces variations in the amount of inserting the prism 11 in the plus Y-direction, thereby producing positional variations of the inclined surface 11c of the prism 11 in the Y-direction. Such positional variations of the inclined surface 11c of the prism 11 in the Y-direction cause positional variations of the first optical axis 21 and second optical axis 22. As such, the holder 12 has a structure that enables regulating the amount of inserting the prism 11 in the plus Y-direction. The following describes this structure.

As illustrated in FIG. 2 and FIG. 3, the holder 12 includes a plate-shaped portion 51.

The plate-shaped portion 51 has the mounting surface 12d of the holder 12. The plate-shaped portion 51 has a circular hole 51a. The circular hole 51a has a circular planar shape.

The prism 11 has a remaining surface 11d.

The remaining surface 11d of the prism 11 is a surface other than the first flat surface 11a, second flat surface 11b, and inclined surface 11c of the prism 11. The prism 11 has a triangular-prism shape. The remaining surface 11d is the bottom surface of the triangular-prism shape.

The holder 12 has a hole 12f. The hole 12f extends from an outer surface 12g of the holder 12 to the inner space 12a of the holder 12. The hole 12f extends from the outer surface 12g toward the remaining surface 11d of the prism 11.

How to use the circular hole 51a and hole 12f will be described later on.

### 1.4 Alignment Mechanism

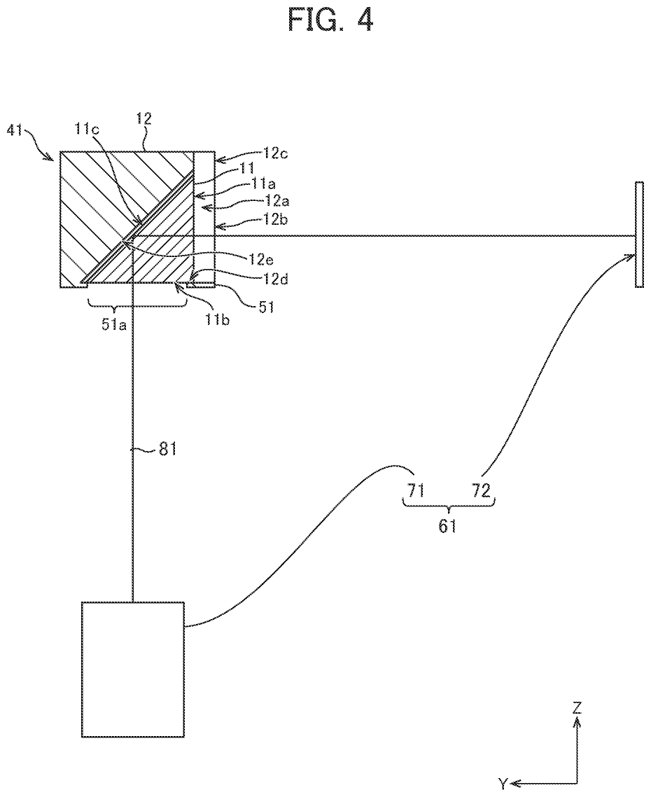

FIG. 4 schematically illustrates the prism block included in the camera module according to the first preferred embodiment, and an alignment mechanism for aligning this prism block.

An alignment mechanism 61 illustrated in FIG. 4 is used for positioning the prism 11 in the Y-direction.

As illustrated in FIG. 4, the alignment mechanism 61 includes a light source 71 and an imaging surface 72.

The light source 71 emits light 81 and irradiates the prism block 41 with the emitted light 81. The light source 71 irradiates the prism 11 with the light 81 via the circular hole 51a of the plate-shaped portion 51. The light 81 casted on the prism 11 enters the second flat surface 11b of the prism 11. The light source 71 is placed in such a manner that the light 81 perpendicularly enters the second flat surface 11b. The light 81 entered into the second flat surface 11b travels through the inside of the prism 11 and reaches the inclined surface 11c of the prism 11. The light 81 reached the inclined surface 11c reflects on the inclined surface 11c. The light 81 reflected on the inclined surface 11c travels through the inside of the prism 11 and reaches the first flat surface 11a of the prism 11. The light 81 reached the first flat surface 11a exits from the first flat surface 11a. The light 81 exited from the first flat surface 11a forms an image of the circular hole 51a. Thus, the light source 71 causes the prism 11 to reflect the light 81 and causes the prism 11 to form the image of the circular hole 51a. The prism 11 forms an image of the circular hole 51a on the imaging surface 72.

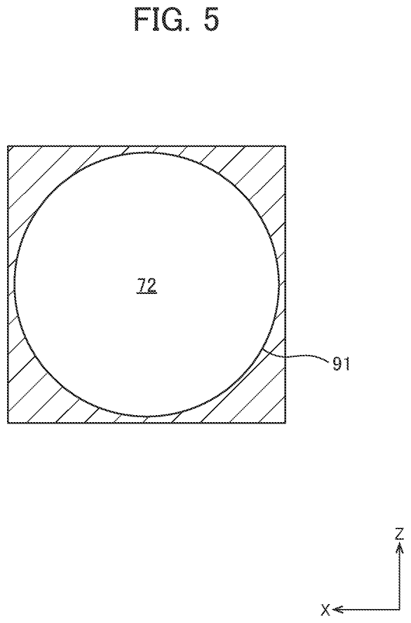

FIG. 5 is a schematic plane view of the imaging surface included in the alignment mechanism, which is for aligning the prism block included in the camera module according to the first preferred embodiment.

As illustrated in FIG. 5, the circular hole 51a of the plate-shaped portion 51 is projected on the imaging surface 72. This forms an image 91 of the circular hole 51a on the imaging surface 72. Since the circular hole 51a has a circular planar shape, the image 91 of the circular hole 51a also has a circular planar shape.

The position where the image 91 of the circular hole 51a is to be formed moves in the plus Z-direction in response to the insertion of the prism 11 into the holder 12 to thus move the prism 11 in the plus Y-direction within the inner space 12a of the holder 12. Accordingly, the position of the prism 11 in the Y-direction can be identified from the plus Z-direction position where the image 91 of the circular hole 51a is formed. Consequently, moving the prism 11 in the Y-direction until the plus Z-direction position where the image 91 of the circular hole 51a is to be formed reaches a target position can place the prism 11 in a desirable position in the Y-direction.

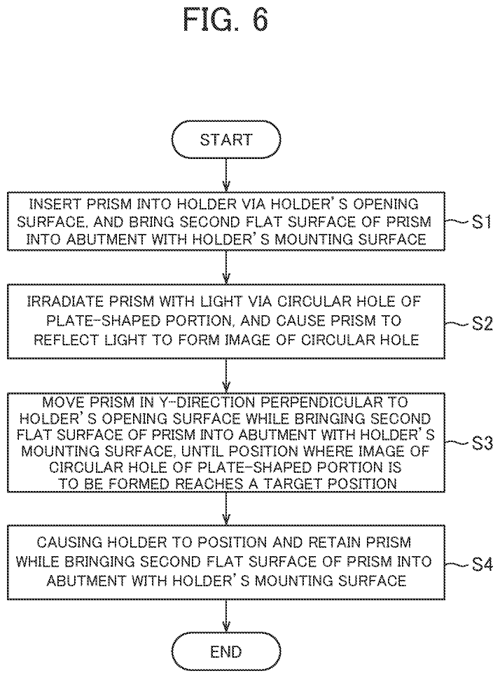

FIG. 6 is a flowchart showing procedures for manufacturing the prism block included in the camera module according to the first preferred embodiment.

To manufacture the prism block 41, Steps S1 to S4 shown in FIG. 6 are executed.

Step S1 is inserting the prism 11 into the holder 12 via the opening surface 12b of the holder 12, and bringing the second flat surface 11b of the prism 11 into abutment with the mounting surface 12d of the holder 12.

Subsequent Step S2 is irradiating the prism 11 with the light 81 via the circular hole 51a of the plate-shaped portion 51 by the use of the alignment mechanism 61, to cause the prism 11 to reflect the light 81 to form the image 91 of the circular hole 51a.

Subsequent Step S3 is moving the prism 11 in the Y-direction perpendicular to the opening surface 12b of the holder 12 while bringing the second flat surface 11b of the prism 11 into abutment with the mounting surface 12d of the holder 12, until the position where the image 91 of the circular hole 51a of the plate-shaped portion 51 is to be formed reaches a target position. This brings the position of the inclined surface 11c of the prism 11 in the Y-direction into a desirable position.

Subsequent Step S4 is inserting a rod-shaped object into the hole 12f of the holder 12, so that the inserted rod-shaped object holds down the remaining surface 11d of the prism 11.

Accordingly, the prism 11 is positioned in the Y-direction. This enables the holder 12 to position and retain the prism 11 with the second flat surface 11b of the prism 11 being in abutment with the mounting surface 12d of the holder 12.

In response to a change in the amount of inserting the prism 11, the position where a light beam that passes through the prism 11 passes also changes. If the end of the prism 11 falls within an effective diameter as the result of an increase in the amount of inserting the prism 11, light-beam vignetting occurs in some cases. However, aligning the position of the prism 11 in the Y-direction by the use of the foregoing alignment mechanism can prevent such light-beam vignetting. Further, this alignment eliminates the need to use the prism 11 that has a size equal to or larger than the effective diameter.

### 1.5 Other Functions of Circular Hole

The circular hole 51a of the plate-shaped portion 51 also has a function to prevent unnecessary scattering light that occurs due to the prism 11, and the circular hole 51a also functions as an aperture diaphragm disposed between the prism 11 and the optical system 13.

The prism 11 undergoes chamfering at the edge of its end in some cases when the prism 11 is formed. If needless light enters the edge, unnecessary reflected light sometimes occurs. In addition, the light entered into the edge causes a flare, a ghost, and the other things. However, the prism block 41, which has the circular hole 51a having a large diameter than an optical-axis effective diameter, can prevent needless light from entering the end of the prism 11, without blocking light beams necessary for imaging.

### 2 Second Preferred Embodiment

Differences between a second preferred embodiment and the first preferred embodiment will be described. What will not be described in the second preferred embodiment are configurations similar to the configurations applied in the first preferred embodiment.

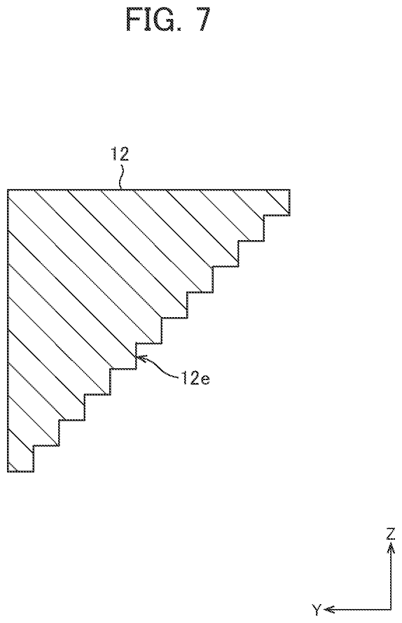

FIG. 7 is a schematic sectional view of a holder included in a camera module according to the second preferred embodiment.

The inclined surface 12e of the holder 12 has an asperity shape in the second preferred embodiment, as illustrated in FIG. 7.

As earlier described, the inclined surface 12e of the holder 12 faces the inclined surface 11c of the prism 11 with a gap therebetween. There is thus an air layer between the inclined surface 12e of the holder 12 and the inclined surface 11c of the prism 11.

As earlier described, the inclined surface 11c of the prism 11 is previously processed into a total-reflection surface. However, even though the inclined surface 11c is processed into a total-reflection surface, the inclined surface 11c cannot completely reflect first light totally in some cases. Hence, the air layer between the inclined surface 12e of the holder 12 and the inclined surface 11c of the prism 11 produces scattering light in some cases. The produced scattering light causes a flare, a ghost, and the other things. The asperity shape of the inclined surface 12e of the holder 12 prevents such scattering light.

The asperity shape of the inclined surface 12e of the holder 12 has a height of about 0.1 to 0.01 mm for instance.

For the holder 12 produced by a 3D printer through a thermal-dissolution staking method, asperities having pitches reflecting the pitches of the stack remain on the inclined surface 12e of the produced holder 12 in some cases, depending on the staking direction. Such asperities remaining on the surface of a fabricated article produced by a 3D printer through the thermal-dissolution staking method are typically removed by polishing the surface. However, in the second preferred embodiment, the asperities remaining on the inclined surface 12e are used as an asperity shape for preventing scattering light. This can shorten a time necessary for producing the holder 12.

### 3 Third Preferred Embodiment

Differences between a third preferred embodiment and the first preferred embodiment will be described. What will not be described in the third preferred embodiment are configurations similar to the configurations applied in the first preferred embodiment.

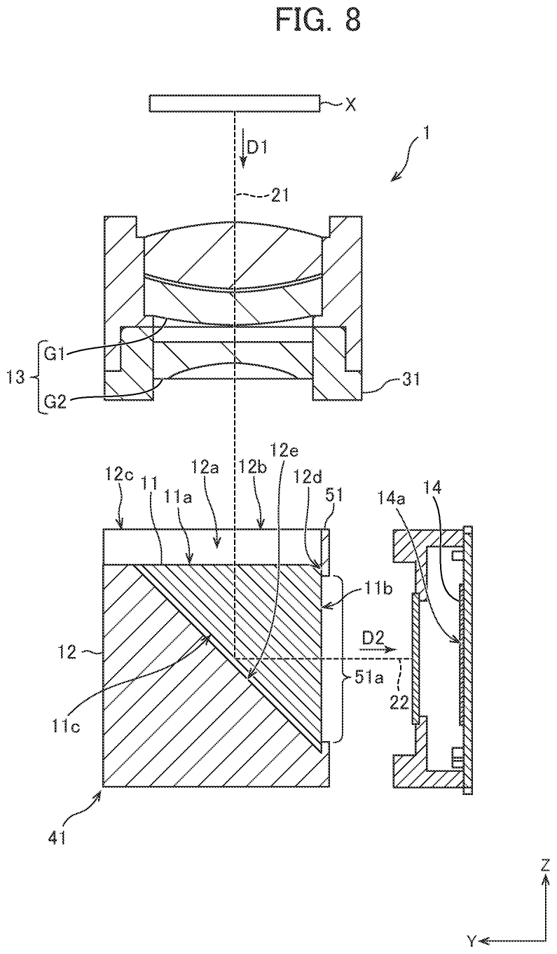

FIG. 8 is a schematic sectional view of a camera module according to the third preferred embodiment.

In the first preferred embodiment, the optical system 13 is disposed at a stage posterior to the stage at which the prism 11 is disposed, as illustrated in FIG. 1. Further, the image pickup unit 14 is disposed at a stage posterior to the stage at which the optical system 13 is disposed. Thus, the prism 11 reflects the first light, which travels in the first direction D1, to thus generate the second light, which travels in the second direction D2. Further, the optical system 13 causes the generated second light to pass therethrough. Further, the image pickup unit 14 receives the transmitted second light.

In the third preferred embodiment by contrast, the prism 11 is disposed at a stage posterior to the stage at which the optical system 13 is disposed, as illustrated in FIG. 8. Further, the image pickup unit 14 is disposed at a stage posterior to the stage at which the prism 11 is disposed. Thus, the optical system 13 causes the first light, which travels in the first direction D1, to pass therethrough. Further, the prism 11 reflects the transmitted first light to generate the second light, which travels in the second direction D2.

Further, the image pickup unit 14 receives the generated second light.

The present disclosure is not limited to the foregoing preferred embodiments. The present disclosure may be replaced with the substantially same configuration as the configurations described in the preferred embodiments, a configuration that exerts the substantially same action and effect as these configurations, or a configuration that can achieve the substantially same object as these configurations.

What is claimed is:

1. A prism block comprising:
a holder having an opening surface and a mounting surface perpendicular to the opening surface; and
a prism configured to receive first light that travels in a first direction, and to cause second light that travels in a second direction perpendicular to the first direction to exit, the prism being positioned and retained by the holder while being in abutment with the mounting surface.

2. The prism block according to claim 1, wherein
the holder includes a plate-shaped portion having the mounting surface, and
the plate-shaped portion has a circular hole having a circular planar shape.

3. The prism block according to claim 1, wherein
the prism has a first flat surface configured to receive the first light, a second flat surface perpendicular to the first flat surface, and configured to cause the second light to exit, and an inclined surface inclined with respect to the first flat surface and the second flat surface, and configured to subject the first light to total-reflection to generate the second light,
the holder has an opposing surface facing the inclined surface with a gap between the inclined surface and the opposing surface, and
the opposing surface has an asperity shape.

4. The prism block according to claim 1, wherein
the prism has a first flat surface configured to receive the first light, a second flat surface perpendicular to the first flat surface, and configured to cause the second light to exit, an inclined surface inclined with respect to the first flat surface and the second flat surface, and configured to subject the first light to total-reflection to generate the second light, and a remaining surface other than the first flat surface, the second flat surface, and the inclined surface, and
the holder has a hole extending from an outside of the holder toward the remaining surface.

5. The prism block according to claim 1, wherein
the prism has a first flat surface configured to receive the first light, a second flat surface perpendicular to the first flat surface, and configured to cause the second light to exit, and an inclined surface inclined with respect to the first flat surface and the second flat surface, and configured to subject the first light to total-reflection to generate the second light, and
the second flat surface is in surface-contact with the mounting surface.

6. A camera module comprising:
the prism block according to claim 1;
an optical system configured to cause the second light to form an image; and
an image pickup element configured to take the image.

7. A method for manufacturing a prism block, comprising:
inserting a prism into a holder having an opening surface and a mounting surface perpendicular to the opening surface via the opening surface, and bringing the prism into abutment with the mounting surface, the prism being configured to receive first light that travels in a first direction, and to cause second light that travels in a second direction perpendicular to the first direction to exit; and
causing the holder to position and retain the prism while bringing the prism into abutment with the mounting surface.

8. The method for manufacturing the prism block according to claim 7, wherein
the holder includes a plate-shaped portion having the mounting surface,
the plate-shaped portion has a circular hole having a circular planar shape, and
the method comprises:
irradiating the prism with light via the circular hole, and causing the prism to reflect the light to form an image of the circular hole; and
moving the prism in a direction perpendicular to the opening surface while bringing the prism into abutment with the mounting surface, until a position where the image is to be formed reaches a target position.
